(19) United States
(12) Patent Application Publication
(10) Pub. No.: US 2025/0327355 A1
(43) Pub. Date: Oct. 23, 2025

(54) FIRE RATED CLADDED DOOR AND METHOD OF ASSEMBLY

(71) Applicant: AADG, INC., New Haven, CT (US)

(72) Inventor: Thomas Rattay, Mason City, IA (US)

(73) Assignee: AADG, INC., New Haven, CT (US)

(21) Appl. No.: 18/640,589

(22) Filed: Apr. 19, 2024

(51) Int. Cl. E06B 5/16

(52) U.S. Cl. CPC E06B 5/16

(57) ABSTRACT

A cladded door apparatuses having cladding coupled to a door such that during a fire the cladding falls off and/or away from the door such that the door may meet fire ratings. One or more adhesive connectors (e.g., adhesive tape, adhesive sealant, or the like) may be used to couple the cladding directly, or through the use of one or more cladding support members (e.g., rods, panels, or the like), to the door. The cladding may be held a particular distance, or a range of distances, away from the door and/or the door frame to optimize the operation of the cladded door apparatus. The use of the adhesive connectors, the cladding support members, and/or the installation thereof, allows for the proper connection of the cladding to the door during normal operation, but allows the cladding to be uncoupled from the door during a fire.

### FIELD

Embodiments of the present disclosure generally relate to cladded door apparatuses, and in particular, cladded door apparatuses that allow for the cladding to separate from the door during a fire.

### BACKGROUND

Cladding on doors allows for architectural designs and/or allows doors to be hidden with the adjacent cladding on walls. However, cladding made of combustible materials are not able to meet fire ratings.

### SUMMARY

As will be described herein, embodiments of the cladded door apparatuses are provided herein, wherein the cladding of the door apparatus is operatively coupled to the door such that during a fire the cladding falls off and/or away from the door such that the door may meet certain fire ratings. In particular, the cladding may be operatively coupled to the door through the use of one or more adhesive connectors (e.g., adhesive tape, adhesive sealant, or the like) directly, or through the use of one or more cladding support members (e.g., rods, panels, or the like). In particular embodiments, the cladding may be held a particular distance, or a range of distances, away from the door and/or the door frame. The use of the adhesive connectors, the cladding support members, and/or the installation thereof, allows for the proper connection of the cladding to the door during normal operation, but allows the cladding to be uncoupled from the door during a fire. That is, the adhesive connectors allows the cladding to separate from the door during a fire, and thus, the cladded door apparatus meets different fire ratings.

One embodiment of the invention is a cladded door apparatus. The apparatus comprises a door, one or more adhesive connectors, and one or more door cladding members operatively coupled to the door using the one or more adhesive connectors. The one or more adhesive connectors are configured to disengage during a fire such that the one or more door cladding members uncouple from the door.

In further accord with embodiments, the cladded door apparatus is a fire rated door that meets a 90-minute rating and is in compliance with UL 10C, NFPA 252, or CAN/ULC S104.

In other embodiments, the cladded door apparatus meets a 180-minute rating.

In still other embodiments, the one or more adhesive connectors comprise one or more sections of an adhesive tape.

In yet other embodiments, the adhesive tape has a thickness ranging from 0.035 to 0.055 inches.

In other embodiments, the one or more adhesive connectors comprise an adhesive sealant.

In further accord with embodiments, a 0.5 square inch of the one or more adhesive connectors have a static shear strength when tested at a temperature of 72 degrees F. that supports 800 to 1200 grams.

In other embodiments, a 0.5 square inch of the one or more adhesive connectors have a static shear strength when tested at a temperature of 150 degrees F. that supports 300 to 600 grams.

In still other embodiments, a 0.5 square inch of the one or more adhesive connectors have a static shear strength when tested at a temperature of 200 degrees F. that supports 150 to 350 grams.

In yet other embodiments, the invention further comprises one or more cladding support members operatively coupled between the door and the one or more door cladding members.

In other embodiments, the one or more cladding support members comprise a plurality of vertical and horizonal cladding support members that form a framework.

In further accord with embodiments, the one or more cladding support members comprise a plurality of brackets operatively coupled between the door and the one or more door cladding members.

In other embodiments, the one or more cladding support members offset the one or more door cladding members a minimum of 0.25 inches from the door or a door frame.

In still other embodiments, the one or more cladding support members offset the one or more door cladding members a maximum of 1.75 inches from the door or a door frame.

In yet other embodiments, the one or more door cladding members comprise non-combustible materials.

In other embodiments, the one or more door cladding members comprise combustible materials.

Another embodiment of the invention is a method of installing a cladded door apparatus. The method comprises assembling one or more adhesive connectors to a door and one or more door cladding members, wherein the one or more adhesive connectors are configured to disengage during a fire such that the one or more door cladding members uncouple from the door.

In further accord with embodiments, the method further comprises assembling one or more cladding support members to the door or the one or more door cladding members using the one or more adhesive connectors or other connectors.

In other embodiments, the one or more cladding support members offset the one or more door cladding members a minimum of 0.25 inches from the door or a door frame, and wherein the one or more cladding support members offset the one or more door cladding members a maximum of 1.75 inches from the door or the door frame.

In still other embodiments, the cladded door apparatus is a fire rated door that meets a 90-minute rating and is in compliance with UL 10C, NFPA 252, or CAN/ULC S104. Moreover, a 0.5 square inch of the one or more adhesive connectors have a static shear strength when tested at a temperature of 72 degrees F. that supports 800 to 1200 grams. Furthermore, a 0.5 square inch of the one or more adhesive connectors have a static shear strength when tested at a temperature of 150 degrees F. that supports 300 to 600 grams. Finally, a 0.5 square inch of the one or more adhesive connectors have a static shear strength when tested at a temperature of 200 degrees F. that supports 150 to 350 grams.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings.

FIG. 1A is a front view of one side of a door frame and door, in accordance with some embodiments of the present disclosure.

FIG. 1B is an exploded perspective view of the door of FIG. 1A, in accordance with some embodiments of the present disclosure.

FIG. 2A is a perspective view of a cladded door apparatus, in accordance with some embodiments of the present disclosure.

FIG. 2B is a front side view of the cladded door apparatus of FIG. 2A, in accordance with some embodiments of the present disclosure.

FIG. 2C is a lock edge view of the cladded door apparatus of FIG. 2A, in accordance with some embodiments of the present disclosure.

FIG. 2D is a top edge view of the cladded door apparatus of FIG. 2A, in accordance with some embodiments of the present disclosure.

FIG. 2E is a perspective exploded view of the cladded door apparatus of FIG. 2A, in accordance with some embodiments of the present disclosure.

FIG. 2F is a perspective view of a cladded door apparatus similar to FIG. 2A with cladding extending past the door, in accordance with some embodiments of the present disclosure.

FIG. 3A is a perspective exploded view of a doubled cladded door apparatus, in accordance with some embodiments of the present disclosure.

FIG. 3B is a perspective view and enlarged views of a cladding support framework for the cladding of the doubled cladded door apparatus, in accordance with some embodiments of the present disclosure.

FIG. 4 is a cross sectional top view of the cladded door apparatus with intumescent, in accordance with embodiments of the present disclosure.

FIG. 5A is a perspective view of a cladded door apparatus with wood cladding in an open position, in accordance with some embodiments of the present disclosure.

FIG. 5B is a perspective view of a cladded door apparatus with wood cladding in a closed position, in accordance with some embodiments of the present disclosure.

FIG. 5C is a perspective view of a cladded door apparatus with stone cladding in an open position, in accordance with some embodiments of the present disclosure.

FIG. 5D is a perspective view of a cladded door apparatus with stone cladding in a closed position, in accordance with some embodiments of the present disclosure.

FIG. 6 illustrates a process for manufacturing and installing a cladded door apparatus, in accordance with some embodiments of the disclosure.

### DETAILED DESCRIPTION

The following detailed description teaches specific example embodiments of the invention; however, other embodiments of the invention do not depart from the scope of the present invention. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including” when used herein, specify the presence of stated features, steps, operations, elements, and/or components, but do not preclude the presence or addition of one or more other features, steps, operations, elements, components, and/or groups thereof.

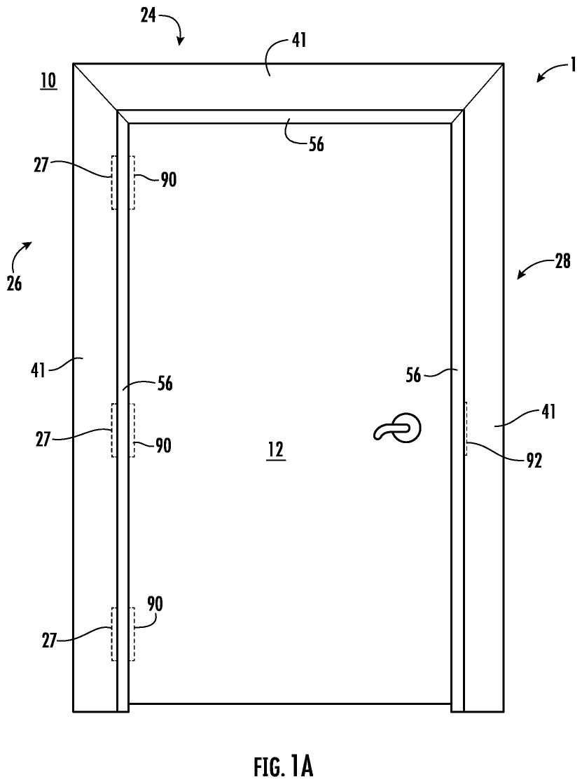

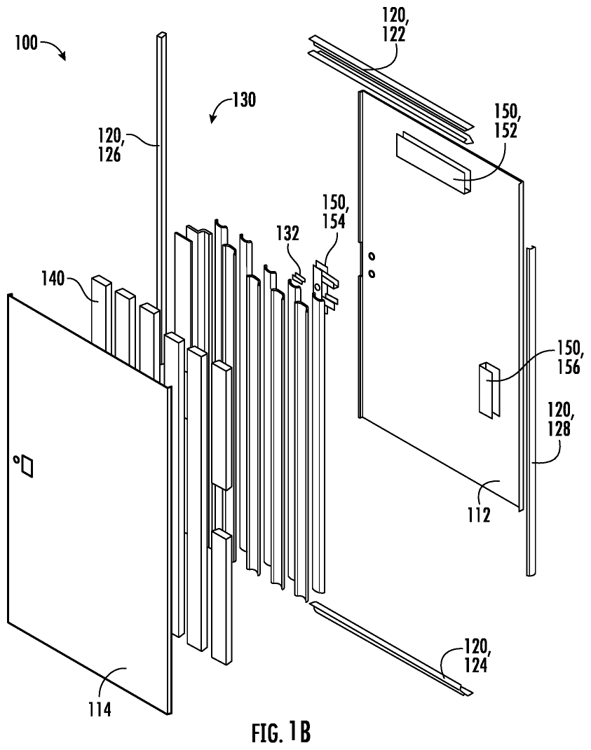

Embodiments of the invention will be described with respect to FIGS. 1A through 5D. FIG. 1A illustrates a door system 10 without cladding, having a door 12 and a door frame 20. As illustrated in FIG. 1A, the door frame 20 may comprise three (3) portions including an upper portion 24 disposed adjacent an upper end of a door opening, and two side portions 26, 28 disposed along either edge of the door opening, with one side portion 26 being on the hinge side of the door 12, and the opposite side portion 28 being on the latch side of the door 12. In some embodiments, the door system 10 may be a double door system, in which case the side portions 26, 28 are both hinge sides of the doors 12, and the door may have a center mullion for the latch sides the doors 12. Each portion 24, 26, 28 may be made up of one or more elongated frame segments (e.g., in some embodiments a pair of elongated frame segments for adjustable door frames 20) of sufficient length to fit the door opening and door 12. When multiple frame segments are used, the frame segments are assembled around the open edges of a wall 8. A first frame segment may be disposed on the outer side of the door opening (e.g., the side of wall 8 that is normally outside of the door 12), and a second frame segment may be disposed on the inner side of the door opening (e.g., the side of the wall 8 that is normally enclosed by the door 12). However, in some embodiments the first frame segment may be disposed on the inner side of the door opening and the second frame segment may be disposed on the outer side of the door opening. The door frame portions 24, 26, 28 may be secured to each other and/or an adjoining structure by frame connectors (e.g., clips, tabs, fasteners, or the like).

As further illustrated in FIG. 1A, a door 12 (or multiple doors for double door systems) may be hung otherwise conventionally within the door opening by hinges 90 secured by fasteners 92 through openings to hinge reinforcements 27 in one (for a single door) or both (for double doors) of the frame side portions 26, 28 so that the door face contacts stop flanges, or the like. The door 12 may be any type of conventional door, any customized door, or the like. However, in particular embodiments the door may be a hollow metal door 110 that has door skins and/or a core 120 that provides different benefits, as will be described herein.

As illustrated in FIG. 1B, the hollow metal door 110 may comprise a first skin 112 (e.g., a first face, or the like) and a second skin 114 (e.g., a second face, or the like). In some embodiments door may also have edge members 120 (e.g., channels, caps, and/or the like), such as an upper edge member 122 (e.g., tope edge member, or the like), a lower edge member 124 (e.g., a bottom edge member, or the like), a first side edge member 126 (e.g., a lock edge member, lock channel, or the like), and/or a second side edge member 128 (e.g., hinge edge member, or the like). In some embodiments the edge members 120 may be separate edge members 120, as illustrated in FIG. 1B, or they may be included as a part of the first skin 112 and/or the second skin 114 (e.g., formed integrally with one of the skins 112, 114, or the like). Moreover, the hollow metal door 110 may comprise a core 130 comprising one or more core stiffener layers 132, core material layers 140, and/or door casings 150 (e.g., reinforcements, hinge casings, lock casings, door operator or closer casings, or the like casings), as will be described in further detail herein. The core 130 may be pre-formed and dropped into the door 110, or a portion thereof (e.g., a skin 112, 114 and/or one or more edge members 120), or the core 130, or portions thereof, may be formed within door 110, or a portion thereof.

In some embodiments the stiffener layer 132 may comprise one or more panels (e.g., corrugated panels, rolled panels, or the like profile panels with ribs, stiffener rods, or the like), one or more matrix layers (e.g., web layers, such has honeycomb, other webbed layers), or one or more individual members 134 (e.g., rods, z-shaped, L-shaped, w-shaped, V-shaped, c-shaped, u-shaped, y-shaped, x-shaped, or the like shaped members). As will be described herein, the one or more stiffener layers 132 may extend between locations adjacent the edge members 120 in one or more orientations (e.g., horizontally, vertically, diagonally, or the like).

When the stiffener layer 132 comprises individual members 134, the one or more stiffener members 134 may be made of any size and/or shape, such as a rod (hollow or solid) that is circular, half circular, conical shaped, triangular, rectangular, square, trapezoidal, pentagonal, hexagonal, heptagonal, octagonal, any other polygonal shape, diverging or converging from one side to the other, uniform, non-uniform, or other like shape. Alternatively, or additionally, the stiffener members 134 may be z-shaped, L-shaped, w-shaped, V-shaped, c-shaped, u-shaped, y-shaped, x-shaped, or the like shaped members. It should be further understood that the one or stiffener members 134 may be individual members separated from each other, may be operatively coupled to each other for additional support (e.g., lateral stiffener members operatively coupling the vertical stiffener members, or the like), and/or may be operatively coupled to or secured within another layer described herein (e.g., one or more core material layers 140) in order to provide stiffening and/or other properties to the door 110. It should be understood that the stiffener members 134 may be made of any type of material including steel, aluminum, other metal, or the like. However, in some embodiments, in order to reduce the amount of steel or other metal used in the door 110, the stiffener members 134 may be made of a fiber reinforced polymer (FRP) (e.g., glass fiber reinforced polymer (GFRP), aramid fiber reinforced polymer (AFRP), carbon fiber reinforced polymer (CFRP), carbonized foam, or the like). In some embodiments, the FRP stiffener members may have glass fibers spirally wrapped about the exterior. The FRP stiffener members may be anisotropic or isotropic in mechanical properties, and generally have significantly higher tensile strength and lower modulus of elasticity than steel. As a result, a stiffener made of FRP may be made of comparable or greater strength than steel, with significantly lower mass.

As illustrated in FIG. 1B, the stiffener members 134 may be a plurality of spaced-apart elongated structural stiffener members 134 that extend substantially between the door edges (e.g., vertically between a bottom edge member 124 and a top edge member 122 and spaced apart between a first edge member 126 and a second edge member 128). Although stiffener members 134 are shown extending vertically from the top edge (e.g., top edge member 122) to the bottom edge (e.g., bottom edge member 124) of the door 110, they may extend horizontally from one side to the other, diagonally, in any other direction, and/or combinations thereof.

Regardless of the type of the type of stiffener member 134, the diameter (D) of the stiffeners members 134 may typically be in the range of 0.25 in to 0.75 in., for example 0.375 in. or 0.5 in. However, in some embodiment the stiffener members 134 may have a width of 0.2, 0.25, 0.3, 0.4, 0.5, 0.6, 0.7, 0.75, 0.8, 0.9, 1.25, 1.5, 1.75, 2.0, 2.5, 3, 4, 5, or the like inches, or range in a width that falls between, overlaps, or falls outside of any of these values. The stiffener diameter (D) may typically be in the range of 20% to 50% of the interior door thickness (DT), and may be in the range of 20% to 30% of DT. In other embodiments, the thickness of the stiffener may extend any distance between the door skins 112, 114. The stiffener members 134 may be provided in number and size to provide sufficient structural integrity to maintain the desired strength of the door 110. The stiffener members 134 may be sized and spaced from interior surfaces of the skins 112, 114 of the door 110 so a gap exists, and there is no direct contact between the mid-portions of the stiffener member 134 between ends and the inner surface of the skins 112, 114 (e.g., the door faces) and/or edge members 120 of the door 110. This may provide a minimal thermally conductive bridge through the door thickness. In the alternative, the stiffener members 134 may be made of another suitable structural material, for example a metal or alloy such as hollow steel tube of 0.40 in (10 mm) thickness (or other thickness).

To hold the stiffener members 134 in place within the door interior, the ends of the stiffener members 134 may be secured to end caps, which are themselves secured to the edges (e.g., edges members 120, such as at the top edge member 122 and/or bottom edge member 124) of the door 110, and/or may have cap apertures (e.g., be notched, or the like) for receiving the ends of stiffeners 134. The end caps may be composed of a thermoplastic polymeric material, such as a polycarbonate, or of any other suitable material such as 14, 16, 18, or 20 gauge steel (or another gauge of steel). The thermoplastic polymeric end cap may be formed with a honeycomb pattern having a plurality of regularly spaced, patterned apertures (e.g., openings, holes, or the like) between flat surface portions, which apertures may be molded during forming of the thermoplastic, or otherwise formed through the thickness of the polymeric sheet. The end cap apertures may have any desired cross-section, such as circular, square, rectangular or any polygonal shape. The polymeric end cap is both thermally and electrically non-conductive. The dimensions may be sized to fill substantially the entire thickness between the barrier faces 112, 114, or may be of lesser or greater thickness than the interior space formed by the barrier faces 112, 114.

In alternate embodiments, the stiffener members 134 may be secured to the edges (e.g., edge members 120) directly via edge member apertures at opposite ends of the door shell formed from the faces 112, 114, and/or the edge members 120. The edge member apertures may correspond to a cross-section of the ends of the stiffener members 134. In another embodiment, the stiffener members 134 are bonded into the edge member apertures that correspond in shape and size to the stiffener ends, with an adhesive (e.g., epoxy, glue, or the like). Alternatively, the stiffener ends may be mechanically locked in position by an interference fit into the end cap apertures. End cap apertures may serve as relief slots for the stiffener ends. Other bonding methods and materials may alternatively or additionally be used to secure the stiffener ends, including but not limited other mechanical fasteners, such as a lock washer in edge member apertures.

In some embodiments, the end cap and/or the edges (e.g., edge members 120) may comprise handling apertures that may be used during manufacturing to hang or otherwise handle the door 110 during manufacturing. Additionally, or alternatively, the end cap and/or the edges (e.g., edge members 120) may include one or more fill material openings, which may be used to allow for filling the door 110 with fill material (e.g., insulation, such as expending foam, or the like) to aid in forming the core 130 within the door 110.

As will be described in further detail herein, the core 130, may include one or more core material layers 140, such as foam 142 (e.g., foam-in place insulation material) that expands when provided around the stiffener members 134 between the door faces 112, 114. As such, the door 110 may have a structural framework that may be made of fiber reinforced polymer (FRP). For example, the reinforced core with thermoplastic end caps reduces (e.g., minimizes, eliminates, or the like) the need for steel end channels used for locating steel stiffeners and the steel channels used for FRP reinforcements, thus reducing the weight of the door 110. The thermoplastic end channels and FRP reinforced rods also reduce the thermal transfer of the door components. These thermoplastic end channels and FRP reinforced rods can be used in hollow metal, wood, and FRP door designs. The FRP may be anisotropic or isotropic in mechanical properties, and generally has significantly higher tensile strength and lower modulus of elasticity than steel. As a result, stiffener members 134 may be made of FRP may be made of comparable or greater strength than steel, with significantly lower mass. FRP stiffener members 134 are also corrosion resistant and provide dimensional stability to the panel under thermal loading.

In other embodiments, instead of the stiffener members 134 being in the shape of rods the stiffener members 134 may be profiled stiffener members 134, such as hat-shaped (as illustrated in FIG. 1B), z-shaped, c-shaped, or other shaped as described herein. The profiled stiffeners may have one or more stiffener apertures that are used to reduce the weight of the door 110 and/or allow material (e.g., liquid, foam, or the like) to pass through the stiffener members 134 and expand to form at least a portion of the core 130. It should be understood that the profiled stiffener members 134 may be assembled in the same or similar way as described with respect to the rod stiffener members 134 previously discussed herein. However, in other embodiments the profiled stiffener members 134 may be operatively coupled to one or more of the edges (e.g., edge members 120, or the like) and/or one or more of the faces 112, 114 through the use of a connector (e.g., welds, adhesives, or the like). It should be further understood that the profiled stiffener members 134 may be pre-assembled with one or more core material layers 134 (e.g., encapsulated within, or the like) in order to form the core 130 that is dropped into the door shell to form the door 110; however, in some embodiments the one or more profiled stiffener members 134 may be assembled to the one or more of the faces 112, 114 and/or edges (e.g., edge members 120, or the like) before the one or more core layers are formed to create the core 130. While the stiffener members 134 illustrated in FIG. 1B are hat-shaped, it should be understood that these stiffener members 134 may have other shapes (e.g., z-shaped, u-shaped, c-shaped, dovetail shaped, x-shaped, y-shaped, w-shaped, m-shaped, n-shaped, or the like) and operate in the same or similar way. The stiffener members 134 used (e.g., regardless of shape) may be different sizes such that some of the stiffener members 134 may extend only partially between the faces 112, 114, and/or some of the stiffener members 116 may extend between the faces 112, 114 and/or between one or more liners (not illustrated) that are operatively coupled to at least one of the faces 112, 114. The profiled stiffener members 134 may be made of steel; however, in some embodiments the profiled stiffener members 134 may be made of alternate materials (e.g., non-metals, hybrid material, bio-based materials, carbonized foam, or the like as described herein) in order to utilize more environmentally friendly materials.

In still other embodiments the stiffener layer 132 may comprises of one or more stiffener panels (not illustrated), such as corrugated panels, rolled panels, or the like profile panels with ribs, or the like. The stiffener panels may have one or more ribs located within the stiffener panel. For example, the one or more ribs may be V-shaped ribs; however, it should be understood that the one or more ribs may have any type of shape (e.g., half circle shape, c-shaped, u-shaped, w-shaped, z-shaped, trapezoidal shaped, dovetail shaped, s-shaped, wave-shaped (e.g., sinusoidal, or the like), corrugated, or any other uniform, non-uniform, or other like shape. It should be understood that the ribs may project from only one side of the stiffener panel, or the ribs may project from both sides of the stiffener panel. The panel may also have ribs of different shapes and/or sizes (e.g., V-shaped and w-shaped in the same panel). Moreover, the one or more stiffener panels may be made of any material, such as aluminum, steel, wood, plastic (e.g., polyurethane, polyisocyanurate, enhanced polystyrene, thermoplastic, polycarbonate, PolyEtherEtherKetone (PEEK), Polyvinylidene fluoride or polyvinylidene difluoride (PVDF), borated plastic, or the like), composites, paper, infused, nanotechnology, reinforced hybrid materials, such as fiber reinforced polymer (FRP) (e.g., glass fiber reinforced polymer (GFRP), aramid fiber reinforced polymer (AFRP), carbon fiber reinforced polymer (CFRP), or the like), coated materials, biomass material (as will be described in further detail herein), graphite polystyrene (GPS) material, or the like, and/or combinations of the foregoing. Like the stiffener members 134, the ribs in the panels may extend in any orientation and/or be any size and/or shape. As such, the one or more ribs may be located in any orientation, such as vertical (with respect to the floor), horizontal (with respect to the floor), any angle with respect to the vertical or horizontal orientations. It should be understood that the small variations from vertical or horizontal may still be considered vertical or horizonal. The ribs and/or the areas between the ribs may or may not be operatively coupled to the core material layers 140, which will be described in further detail below.

In still other embodiments, the stiffener layer 132 of the core 130 may comprise of one or more matrix layers (e.g., web layers, such has honeycomb, or other webbed layers). The one or more matrix layers, like the stiffener panel, may extend any distance between the faces 112, 114 and/or edge members 120. The one or more matrix layers may be any type of matrix layer that may comprise of uniform and/or non-uniform structured matrix with apertures extending partially or completely therethrough (e.g., extending from one side of the layer to another in any orientation). In other embodiments, the stiffener layer 132 may comprise one or more solid layers (e.g., liquid for foam layers that turn solid, cushioned layers, hard layers, layers that have solid structure but include spaces of different sizes that are filled with air or other material, or the like, such as foam, plastic, insulation, or other like layers), or the like that may provide additional strength to the core 130.

The core material layer 140 may include different materials that provide one or more benefits, as will be described herein. In some embodiments, the core material layer 140 may include insulation, such as expanding foam insulation, or the like, to aid in forming the core 130. In some embodiments, a curable and hardenable insulation material may be used as a core material layer 140. For example, the core may use insulation material disposed between adjacent stiffeners layers 132, such as the stiffener members 134 (e.g., between rods, or the like) and/or between panels and/or the ribs thereof. The insulation material may fill at least a portion of the interior cavity between the faces 112, 114. The insulation material may be expanded foam, such as polyurethane expanding foam that uses a blowing agent. The foam, when cured, acts to provide thermal insulation through the thickness of the panel. Additionally, the cured foam may adhere to and aid in locking the stiffeners layer 132 (e.g., stiffener members 134, panels, or the like) in place to restrict (e.g., reduce, prevent, or the like) movement of the stiffeners layer from side-to-side (e.g., between edges) and/or between faces 112, 114. Moreover, the stiffener layer 132 composition may also be selected so that the insulation material, when cured, chemically bonds to the stiffener surface so that the stiffener layer 132 and insulation are integral with one another.

In other embodiments, additionally or instead of expanding foam insulation, the one or more core material layers 140 may be polystyrene, polyurethane, polyisocyanurate, kraft paper honeycomb core, graphite polystyrene (GPS), biobased materials, or the like materials.

In some embodiments, it should be understood that the one or more core material layers 140 may be formed from graphite polystyrene (GPS) material. The GPS material, when compared to traditional insulation materials, may provide improved thermal and air leakage performance resulting in energy savings and reduced environmental impact. While the GPS material provides improved thermal and air leakage performance, the GPS material will not reduce the performance or structural integrity of the door 110. The use of the GPS material aids in achieving a lower carbon footprint of the manufacturing of the core 130 and/or doors 110 formed therefrom. In addition to the improved thermal and air leakage performance, the use of GPS material in the core 130 may provide improved sound abatement (e.g., STC ratings).

In other embodiments, the one or more core material layers 140 may utilize other types of materials that provide environmental benefits, such as biomass material, and in particular hemp material or bio-based carbonized foam. For example, using biomass material may result in a lighter weight energy efficient core 130 and/or door 110 formed therefrom. The core 130 may be made from the biomass material may be formed through the use of layering composites, pressing a composite material (e.g., such as hemp, carbonized foam, or the like), structural reaction injection molding (SRIM), 3D printed, or the like. The biomass material may provide improved thermal and/or air leakage performance resulting in energy savings. The biomass material may be formed from plant fibers (e.g., generally cellulose fibers, or the like), alone or in combination with other components such a lignin. The bio-based material may include hemp, cotton, jute, flax, ramie, sisal, bagasse, bamboo, coconut, or the like fibers, or combinations thereof. It should be understood that the biomass materials may include only biomass material, or may utilize other types of materials, such polymers, coal, pitches, or the like, and/or other carbon sources (e.g., from biproducts of other industries), which could be combined to form the carbonized foam.

In addition to the biomass material being lighter, in particular configurations it may be utilized as a stiffener layer 132, such as a stiffener panel, and as such, may reduce (e.g., eliminate or reduce the size of, number of, or the like) other elements (e.g., steel stiffeners, edge members, end caps, or the like). The use of bio-based material in the core may reduce (e.g., lessen, eliminate, or the like) the use of traditional materials, such as polystyrene, polyurethane, polyisocyanurate, kraft paper honeycomb core, or the like, which reduces the carbon footprint of the door, and/or the manufacturing costs.

The use of the GPS material, the biomass material, the carbonized foam, and/or the other materials described herein may be used as one or more core material layers 140 within the core 130. For example, a biomass material, such as hemp, may be used along with a carbonized foam in order to provide improved properties of the core 130. As such, regardless of the type of materials, the types of core materials and/or other layers (e.g., stiffener, solid, matrix, fluid filled) and/or the size of the barrier (e.g., door that is 1½, 1¾, 2, 2¼, 2½, 2¾, 3, 4, or the like inch thick door, or ranges between, overlaps, or falls outside of these values), the one or more layers within the core described herein may have different thicknesses.

As described herein, the use of the one or more core material layers 140, the stiffener layer 132, or the like may be pre-formed into a core that may be dropped into the door shell, or a portion thereof, or may be formed within the door shell, or a portion thereof.

The door 110, such as the door shell, may comprise various casings 150 (e.g., otherwise described as reinforcements, or the like). The casing 150 may comprise plates, blocks, inserts, hollow members, or the like that provide reinforcement for door hardware, such as a door closer/opener casing 152, locking mechanism casing 154 (e.g., mortis lock, deadbolt lock, cam lock, electronic lock, smart lock, or the like), exit device reinforcements 156, hinge reinforcements (e.g., butt hinge, barrel hinge, spring loaded hinge, concealed hinge, overlay hinge, offset hinge, continuous hinge, geared hinge, or the like), or the like.

Regardless of the type of door 110 and/or the core 130 thereof, the door 110 may be used within cladded door apparatus 100. As such, the cladded door apparatus 100 comprises the hollow metal door 110, cladding 160, such as one or more door cladding members 162 (e.g., one or more solid cladding members 164, one or more flexible cladding members 166, or the like), and/or more one or cladding support members 180 (e.g., described in further detail below), which may be any orientation, such as vertical cladding support members 184 and/or horizonal cladding support members 186. In other embodiments, the support members 180 may be described as spacers, or the like.

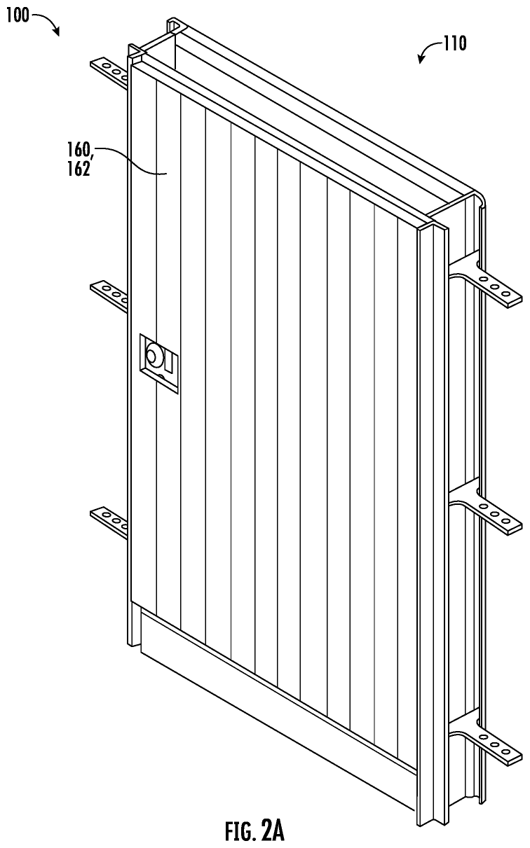

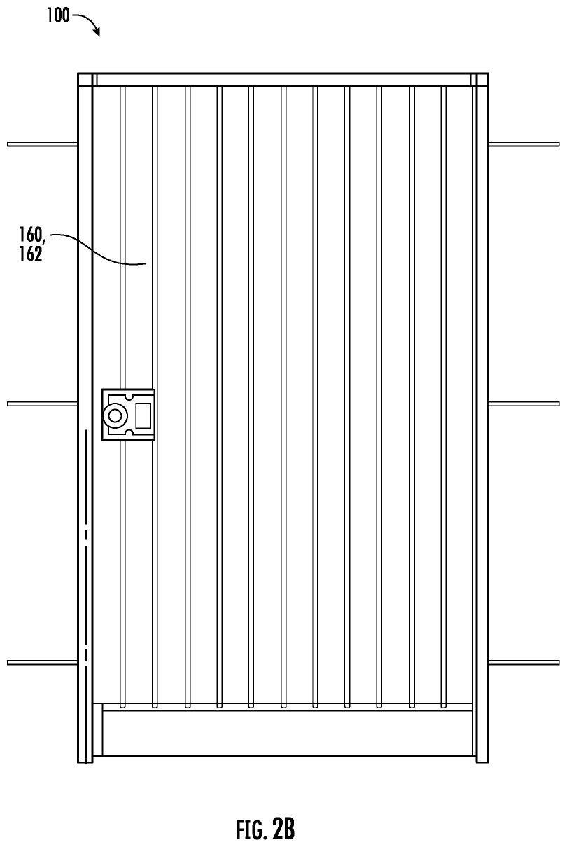

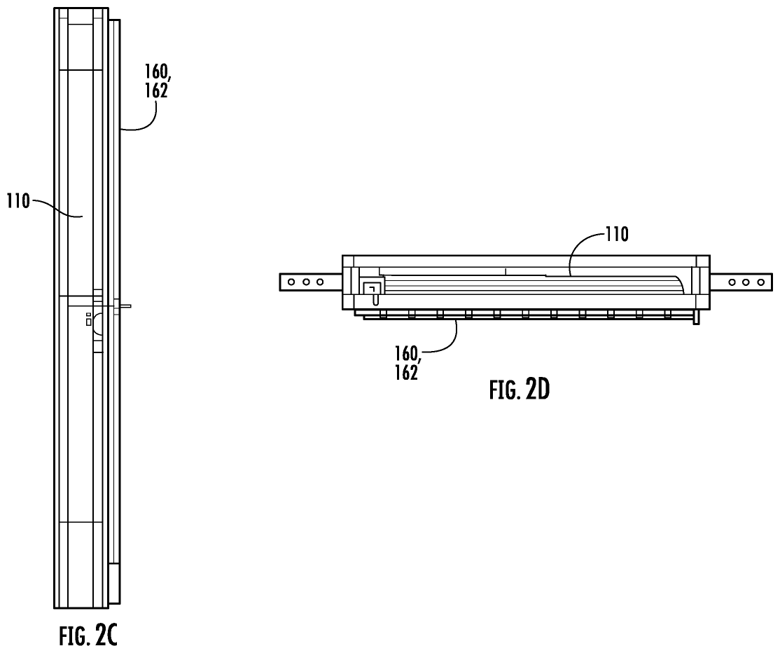

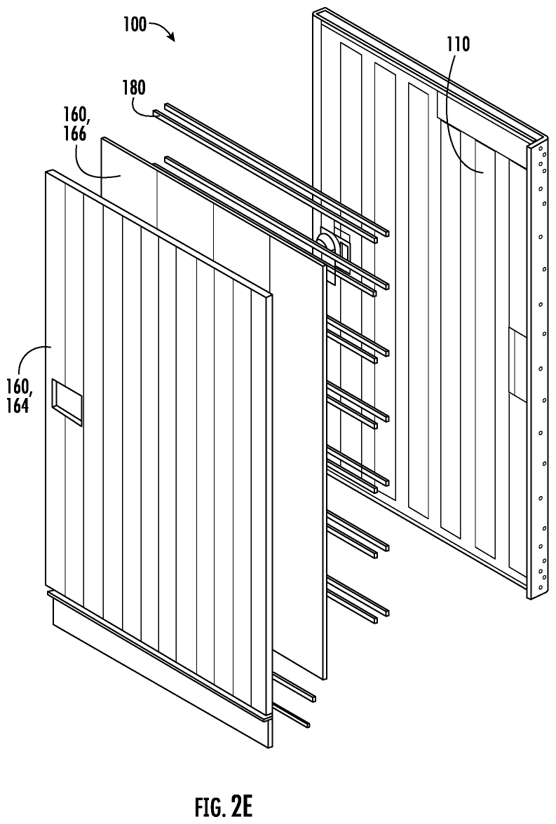

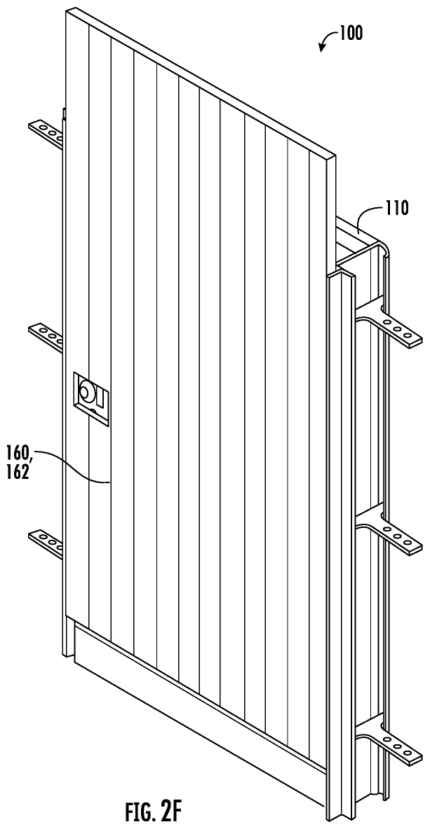

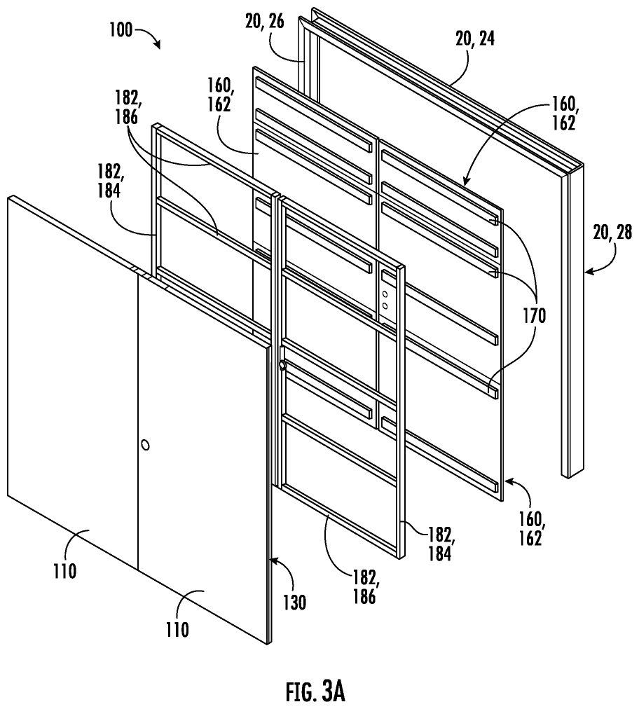

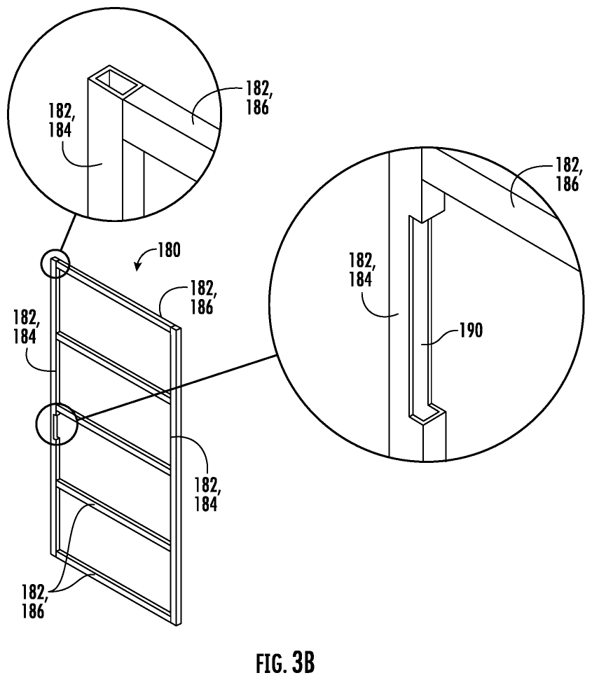

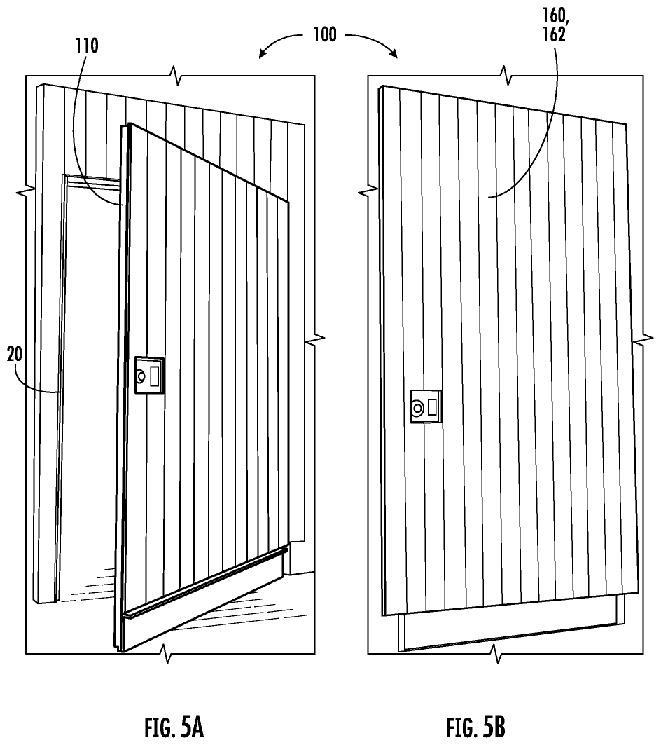

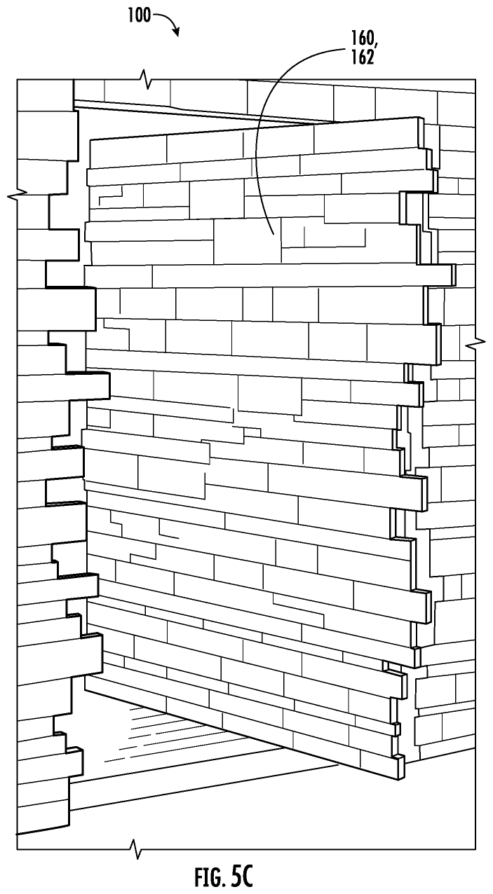

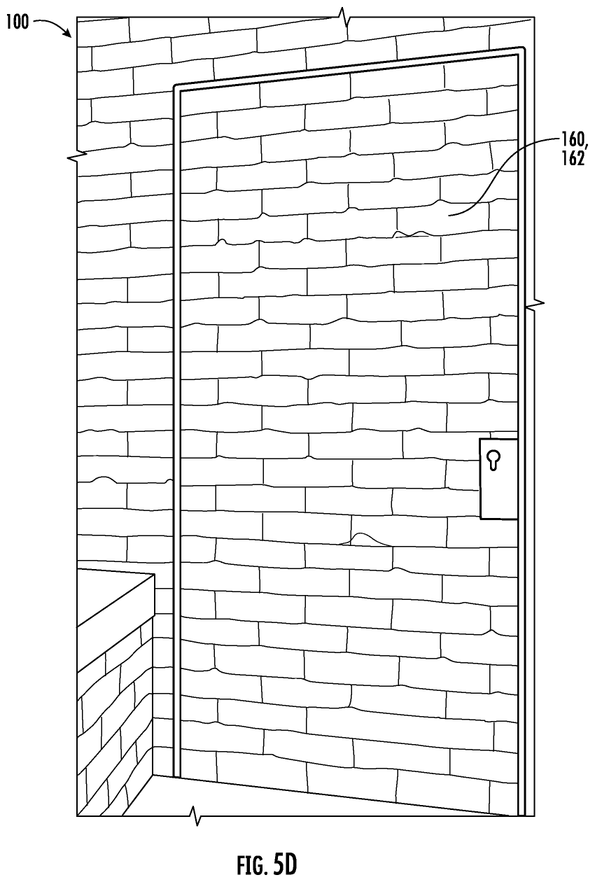

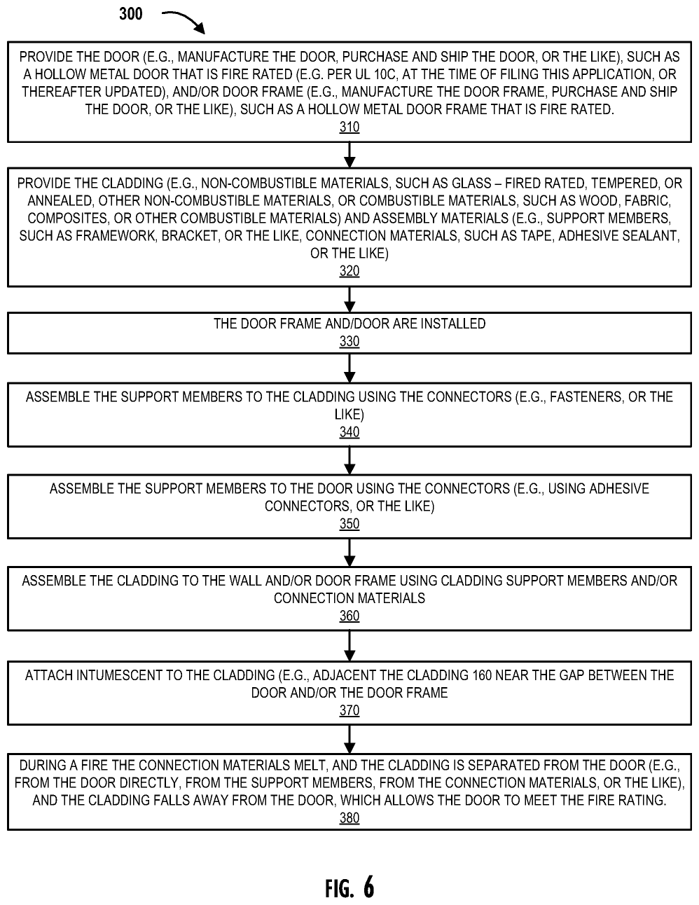

As illustrated in FIGS. 2A through 2E, the cladded door apparatus 100 may comprise cladding 160 that is the same or similar size as the door 110. Alternatively, the cladded door apparatus 100 may comprise cladding 160 that extends past the footprint of the door 110, as illustrated in FIG. 2F. Moreover, in some embodiments, the cladded door apparatus 100 may be a single door apparatus 100, as illustrated in FIGS. 2A through 2E, or it may be a double door apparatus 110, as illustrated in FIG. 3A. The door cladding 160 may be made of wood as illustrated in FIGS. 5A and 5B. In other embodiments, the door cladding 160 may be made of other types of materials, such as stone or the like, as illustrated in FIGS. 5C and 5D. Consequently, the door cladding 160 may be made of combustible materials, such as wood (e.g., sold wood, laminated wood, compressed wood, wood fibers, veneered wood, laminate (e.g., high-pressure laminate, or the like, decorative overlay, or the like)) or other types of materials that may be combustible. Alternatively, the door cladding 160 may be made of non-combustible materials, such as glass, stone, masonry, ceramics, marble, or the like.

Regardless of the type of door cladding 160, the door cladding 160 may be operatively coupled to the door 110 directly or through the use of connectors 170, and/or one or more cladding support members 180. In some embodiments, the door cladding 160 may be operatively coupled to the door 110 directly using the connectors 170. The connectors 170 may comprise an adhesive connector 172 that is applied as a liquid that hardens, a paste, a puddy, as a tape, or other like adhesive connector 172 that may be applied in different ways. In particular embodiments, the adhesive connector 172 may be applied as an adhesive tape 174. In some embodiments, the adhesive tape 174 may comprise an acrylic foam tape with one or more film liners (e.g., polyethylene film, or the like). The adhesive tape 174 (e.g., pressure-sensitive tape, or the like) may be a one-sided tape or a two-sided tape. The adhesive tape 174 may be able to bond with different types of substrates, such as metals, glass, plastics, wood, paints, coatings, or the like. In some embodiments the adhesive tape 174 may meet flammability tests (e.g., FAR 25.853, as defined at the time of filing or as updated in the future). The adhesive tape 174 may have a thickness of 0.02, 0.025, 0.03, 0.035, 0.04, 0.045, 0.05, 0.055. 0.06, 0.065, 0.070, or the like inches or may range between, overlap, or fall outside of these thicknesses.

The adhesive tape 174, or other adhesive application (e.g., liquid, gel, glue, or the like), may have the desired strength at normal operating temperatures, but may have reduced strength when heated, such as during a fire event. For example, during static shear testing at temperatures of 72 degrees F. a 0.5 square inch of tape (or application of adhesive over the same area) may be able to support 800-1,200 g (or range between any number therein, such as 900-1,000 g, or the like) for more than 10,000 minutes. Moreover, during static shear testing at temperatures of 150 degrees F. a 0.5 square inch of tape (or application of adhesive over the same area) may be able to support 300-600 g (or range between any number therein, such as 400-500 g, or the like) for more than 10,000 minutes. Additionally, during static shear testing at temperatures of 200 degrees F. a 0.5 square inch of tape (or application of adhesive over the same area) may be able to support 150-350 g (or range between any number therein, such as 200-300 g) for more than 10,000 minutes. Furthermore, during static shear testing at temperatures of 300 degrees F. a 0.5 square inch of tape (or application of adhesive over the same area) may support 75-125 g for four hours.

Additionally, or alternatively, in particular embodiments, the adhesive sealant may comprise a polyurethane adhesive sealant. As such, in some embodiments, the adhesive sealant may have a tensile strength that ranges from 200 to 400 pounds per square inch (or range between any number therein, such as 275-325 lbs. per square inch) at temperatures between negative 25 degrees F. and 180 degrees F.

In some embodiments, additionally or alternatively, the connectors 170 may be fasteners (e.g., bolts, nuts, screws, rivets, clamps, clips, or the like) that are configured to operatively couple the door cladding 160 to the door 110 directly, or through the use of cladding support members 180 (discussed in further detail below). In some embodiments, like the adhesive connectors 172, the fasteners may be configured to operatively properly during normal operation, but may disengage (e.g., a portion of the fastener or another connector to which the fastener is operatively coupled may melt, degrade, or the like) from the cladding 160, cladding support members 180, and/or the door 110 during a fire.

As illustrated in FIGS. 3A and 3B, in some embodiments, the door cladding 160 may be operatively coupled to the door 110 through the use of cladding support members 180. The cladding support members 180 may be the same as or similar to the stiffener layers 132 previously discussed herein. As such, in some embodiments, the support members 180 may be individual support members 180 of any size and/or shape which may be hollow, solid, partially hollow, partially solid, combinations thereof, or the like. As such, the support members 180 may comprise rods that are circular, half-circular, conical shaped, triangular, rectangular, square, trapezoidal, pentagonal, hexagonal, heptagonal, octagonal, any other polygonal shape, diverging or converging from one side to the other, uniform, non-uniform, or other like shape. As further illustrated in FIGS. 3A and 3B, the support members 180 may be assembled as a framework 182 (e.g., pre-assembled, assembled in one or more parts on the door 110, cladding 160, combinations thereof, or the like). In some embodiments, the framework 182 may include the cladding support members 180 (e.g., circular, square, rectangular, oval, uniform, non-uniform, or the like), which may be in any orientation, such as vertical cladding support members 184 and/or horizonal cladding support members 186. As illustrated in FIG. 3A, the framework 182 may comprise outer frame support members, such as first and second vertical side cladding support members 184 and upper and lower horizontal cladding support members 186. Furthermore, one or more intermediate horizonal cladding support members 186 may extend at least partially between the first and second vertical side cladding support members 184. In further embodiments, as illustrated in FIG. 3B, the framework, in particular the cladding support members 180 may comprise one or more recesses 190 in order to prevent the framework 182 from interfering with door hardware (e.g., locks, handles, door operators, door closers, hinges, or the like).

In some embodiments, the door cladding 160, directly or through the use of the connectors 170 and/or cladding support members 180, may be assembled to the door 110 such that an inner surface of the cladding 160 is spaced from the surface of the door 110 by a distance of 2, 1.8, 1.75, 1.7, 1.6, 1.5, 1.4, 1.3, 1.25, 1.2, 1.1, 1.0, 0.9, 0.8, 0.75, 0.7, 0.6, 0.5, 0.4, 0.3, 0.25, or the like inches, or range between, overlap, and/or fall outside of any of these values. Moreover, the cladding 160, directly or through the use of the connectors 170 and/or cladding support members 180, may be assembled to the door 110 such that an inner surface of the cladding 160 is spaced from the surface of the door frame 20 by a distance of 2, 1.8, 1.75, 1.7, 1.6, 1.5, 1.4, 1.3, 1.25, 1.2, 1.1, 1.0, 0.9, 0.8, 0.75, 0.7, 0.6, 0.5, 0.4, 0.3, 0.25, or the like inches, or range between, overlap, and/or fall outside of any of these values.

It should be further understood that the door cladding 160 on the door 110 may overhang the door frame 20. For example, in some embodiments, the overhang of the cladding 160 over the door frame 20 by a distance of 0.05, 0.075, 0.1, 0.125, 0.150, 0.175, 0.2, 0.225, 0.25, 0.3, 0.4, 0.5, 0.6, 0.7, 0.8, 0.9, 1.0, 1.25, 1.5, 2.0, 2.5, 3, 4, 5, 6, 7, 8, 9, 10, 11, 12, 18, 24, 30, 36, 42, 48, or the like, inches, or range between, overlap, and/or fall outside of any of these values. This overhang may allow the door cladding 160 on the door to blend (e.g., align, extend adjacent to, overlap, interlock, or the like) with cladding located on the wall, door frame 20, and/or other surface. Additionally, or alternatively, cladding attached to a wall may overhang at least a portion of the door frame 20, such as a distance of 0.05, 0.075, 0.1, 0.125, 0.150, 0.175, 0.2, 0.225, 0.25, 0.3, 0.4, 0.5, 0.6, 0.7, 0.8, 0.9, 1.0, 1.25, 1.5, 2.0, 2.5, 3, 4, 5, or the like inches, or range between, overlap, and/or fall outside of any of these values, depending on the size of the door frame 20.

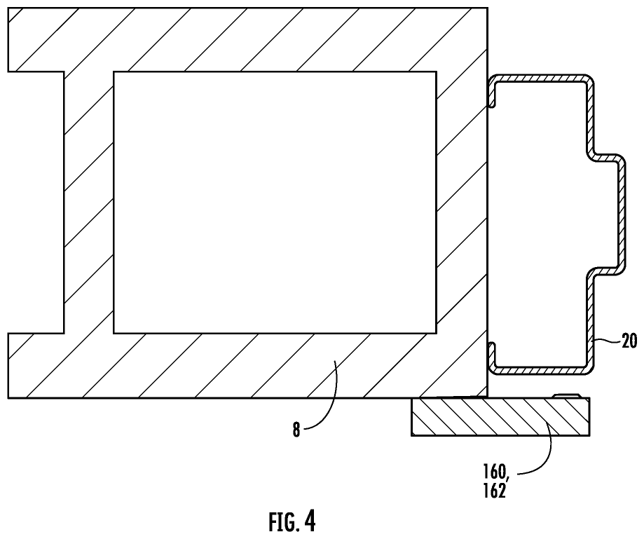

In some embodiment intumescent 200 may be utilized on the door 110, door frame 20, door cladding members 160, cladding support members 180, wall and/or frame 20 cladding, or the like in order to aid in providing additional protection between the cladding members 160 and a fire in order to aid in meeting the fire testing. In particular embodiments, the intumescent 200 may be located on the cladding (e.g., door cladding 160, wall cladding, frame cladding, or the like). For example, the intumescent 200 may be located on the inner surface of cladding, where the cladding covers the face of the door frame 20 (e.g., from the wall and/or from the door 110). In particular embodiments, intumescent 200 may be required in configurations were the cladding 160 is made of combustible materials and the cladding 160 is attached to the wall 8 and extends over at least a portion the door frame 20, as illustrated in FIG. 4. Additionally, or alternatively, the intumescent may be applied to the head or jamb rabbets of the door frame 20.

The cladded door apparatus 100 may be fired rated for 20, 30, 45, 60, 90, 120, 150, 180, or more minutes in accordance with standard testing, such as UL 10C (R2021), NFPA 252 (2017), and/or CAN/ULC S104 (R2020).

The present invention configured to secure the cladding 160 on the door during normal ambient operating conditions; however, in the event of elevated temperatures, the cladding 160 is disengaged from the door 110 in order to meet fire rating testing. That is, when a fire is located on the opposite side of the 110 from the cladding 160, the fire will heat the door 110, and thus, the connectors 170 (e.g., the adhesive connectors 172), until the connectors 170 degrade and allow the cladding 160 to disengage from the door 110 (directly or through the use of the cladding support members 180) before the cladding 160 combusts. Based on the temperature of the fire, the weight of the cladding 160, the connection 170 (e.g., type, amount, or the like), the size of the door and/or door frame (e.g., height, width, thickness, or the like), or the like, the cladding 160 (with or without the cladding support members 180) may begin to fall off the door 110 (or cladding support members 180 thereof) and/or completely fall off the door 110 in order to aid in restricting (e.g., preventing, reducing, or the like) a fire located on the opposite side of the door from spreading to the cladding 160. In some embodiments the cladding 160 may begin to fall off and/or completely fall off of the door 110 (or cladding support members 180 thereof) within 1, 2, 3, 4, 5, 6, 7, 8, 9, 10, 11, 12, 13, 14, 15, 16, 20, 21, 22, 23, 24, 25, 26, 27, 28, 29, 30, or the like minutes from the start of the fire test (e.g., when door 110 is exposed to the fire on the opposite side). It should be understood that the door cladding 160 (with or without the cladding support members 180) may fall off the door 110 in an amount of time that falls between, overlaps, or falls outside of any of these values.

FIG. 6 illustrates a process for the manufacture, installation, and/or operation of the cladded door apparatus 100. FIG. 6 illustrates in block 310 that the door 12 is provided. (e.g., manufacture the door, purchase and ship the door, or the like), such as a hollow metal door 110 that is fire rated (e.g., Per UL 10c, at the time of filing this application, or thereafter updated). Moreover, the door frame 20 is provided (e.g., manufacture the door frame 20, purchase and ship the door frame 20, or the like), such as a hollow metal door frame 20 (e.g., with or without a core) that is fire rated (e.g., Per UL 10c, at the time of filing this application, or thereafter updated).

Block 320 of FIG. 6 further illustrates that the cladding 160 is provided (e.g., manufactured, purchased, or the like). The one or more cladding members 160, as discussed herein may be any shape and size, may be single cladding members 160 or multiple cladding members 160, may be made of any type of material (e.g., non-combustible materials, such as glass-fired rated, tempered, or annealed, other non-combustible materials, or combustible materials, such as wood, fabric, composites, or other combustible materials). Moreover, other materials may also be provided (e.g., manufactured, purchased, or the like), such as the cladding support members 180 (e.g., support members, such as framework, brackets, or the like), the connectors 170 (e.g., adhesive connectors 172, fasteners, such as screws, bolts, nuts, rivets, pins, or the like), intumescent 200, door hardware (e.g., handles, hinges, locks, door closers, door openers, or the like), or the like may be provided (e.g., manufactured, purchased, or the like).

FIG. 6 illustrated in block 330 that the door frame 20 and/door 12 (e.g., hollow metal door 110) are installed. It should be understood that the door frame 20 and/or door 12 may be installed using traditional methods for fire rated door apparatuses.

Blocks 340 and 350 of FIG. 6 further illustrates that the cladding support members 180 are applied to the cladding 160 and/or the door 110 through the use of the connectors 170 that are used to operatively couple the cladding 160, the door 110, and/or the cladding support members 180 together. In some embodiments, it should be understood that the door cladding 160 may be operatively coupled to the door 110 directly through the use of the connectors 170 and without the use of the cladding support members 180. In other embodiments, the cladding support members 180 may first be assembled to the door cladding 160 through the use of the connectors 170, as illustrated in block 340 of FIG. 6. For example, in some embodiments, fasteners may be used to operatively couple one side of the cladding support members 180 to the cladding 160. Thereafter, the adhesive connectors 172 may be used to operatively couple the cladding support members 180 to the door 110, as illustrated in block 350 of FIG. 6. For example, in some embodiments the adhesive connectors 172 may be used to operatively couple the cladding support members 180 to the door 110. Additionally, or alternatively, the cladding support members 180 may be operatively coupled to the door 110 first, and thereafter, the cladding 160 may be operatively coupled to the cladding support members 180 (e.g., using connectors 170, such as adhesive connectors 172, fasteners, or the like).

Block 360 of FIG. 6 further illustrates that the cladding 160 is operatively coupled to a wall and/or the door fame 20 through the use of the connectors 170 (e.g., adhesive connectors 172, fasteners, or the like). The cladding 160 may be held in place temporarily (e.g., using sealant, tape, or the like) allowing the adhesive connectors 172 (e.g., adhesive tape, adhesive sealant, or the like) to cure for the required amount of time based on the type of adhesive.

FIG. 6 further illustrates in block 370 that the intumescent may be placed on the inner surface of the cladding that is facing the door 110, in particular on the edge of the cladding 160, such as where the cladding 160 (e.g., wall cladding, door cladding, or the like) covers the outer surface of the door frame 20.

FIG. 6 further illustrates in block 380 that during a fire, the connectors 170 disengage (e.g., a portion of the fastener, adhesive, or another connector to which the cladding 160 and/or support members 180 are operatively coupled, may melt, degrade, or the like) from the cladding 160, cladding support members 180, and/or the door 110 during a fire. As such, the cladding 160 falls off of (e.g., away from, or the like) the cladding support members 180 and/or the door 110, such that the cladding 160 does not catch fire, and thus, the cladded door apparatus 100 is able to meet fire ratings.

It should be understood that embodiments of the present invention may be utilized for any type of door 12 (e.g., any hollow metal door 110, or the like) and/or cladded door apparatus 100. As such, not only does the fire rated door 12 utilize cladding 160 while still maintaining its fire rating, but the door may also provide other benefits, at least in part through the use of its core 130. As such, the core 130, such as the core materials 140, may provide different types of benefits. For example, the cladded door apparatus 100 may be used to aid in reducing heat transfer, sound, or the like. Moreover, in some embodiments the cladding door apparatus 100 may protect against forced entry (FE) and/or bullet resistant (BR) (otherwise described as FEBR doors openings) by using ballistic resistant materials such as steel armor, composite BR fiberglass, Kevlar, BR composites, woven layers, UHMWPE materials, or other like materials as part of the core. As such, the door 12 and/or door frames 20 of the present disclosure may provide resistance to and protection from a variety of physical impacts by projectiles. In particular, the cladding door apparatus 100 may be structured to provide various UL level protection from ballistic projectiles (e.g., firearm, or the like) and also protection from other projectiles such as debris or shrapnel. For example, the cladding door apparatus 100 may have UL752 Level 1 (9 mm handgun) to UL 752 Level 10 (.50 Caliber Rifle) protection, and in particular embodiments UL752 level 1 (9 mm), UL752 level 2 (.357 Magnum), UL752 level 3 (.44 Magnum), UL752 level 4 (.30 Caliber Rifle), UL752 level 5 (7.63 Caliber Rifle) UL752 level 6 (9 mm Rifle), UL752 level 7 (5.56 mm), UL752 level 8 (7.62 mm), UL752 level 9 (.30-06 rifle), UL752 level 10 (.50 caliber rifle), or the like protection, or have protection that ranges between, overlaps, or falls outside of these levels of protection. Furthermore, the door 12 and/or door frame 20 may also be rated to withstand 5, 10, 15, 20, 25, 30, 40, 50, 60, or the like minutes of simulated “mob” attack, or range between, overlap, or outside of these levels of protection. Moreover, the cladding door apparatus 100, may be structured to exhibit electrical resistance, provide electronic shielding from radio frequency and medium frequency waves, or the like.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the invention. For example, words such as “distal,” “proximal,” “upper,” “top,” “bottom,” “lower,” “left,” “right,” “horizontal,” “vertical,” “upper,” and “lower”, or other like terminology merely describe the configuration shown in the figures. The referenced components may be oriented in an orientation other than that shown in the drawings and the terminology, therefore, should be understood as encompassing such variations unless specified otherwise.

It will be understood that when an element is referred to as “operatively coupled” to another element, the elements can be formed integrally with each other, or may be formed separately and put together. Furthermore, “operatively coupled” to can mean the element is directly coupled to the other element, or intervening elements may be present between the elements. Furthermore, “operatively coupled” may mean that the elements are detachable from each other, or that they are permanently operatively coupled together.

When components are described as being parallel or perpendicular to other components, it should be understood that this many encompass the components being exactly parallel or perpendicular, or generally parallel or perpendicular in which the components deviate from exactly parallel or perpendicular (e.g., +/−1, 2, 4, 6, 8, 10, 15, 20, 25, or the like degrees from exactly parallel or perpendicular).

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A cladded door apparatus, the apparatus comprising:
a door;
one or more adhesive connectors; and
one or more door cladding members operatively coupled to the door using the one or more adhesive connectors;
wherein the one or more adhesive connectors are configured to disengage during a fire such that the one or more door cladding members uncouple from the door.

2. The cladded door apparatus of claim 1, wherein the cladded door apparatus is a fire rated door that meets a 90-minute rating and is in compliance with UL 10C, NFPA 252, or CAN/ULC S104.

3. The cladded door apparatus of claim 2, wherein the cladded door apparatus meets a 180-minute rating.

4. The cladded door apparatus of claim 1, wherein the one or more adhesive connectors comprise one or more sections of an adhesive tape.

5. The cladded door apparatus of claim 4, wherein the adhesive tape has a thickness ranging from 0.035 to 0.055 inches.

6. The cladded door apparatus of claim 1, wherein the one or more adhesive connectors comprise an adhesive sealant.

7. The cladded door apparatus of claim 1, wherein a 0.5 square inch of the one or more adhesive connectors have a static shear strength when tested at a temperature of 72 degrees F. that supports 800 to 1200 grams.

8. The cladded door apparatus of claim 1, wherein a 0.5 square inch of the one or more adhesive connectors have a static shear strength when tested at a temperature of 150 degrees F. that supports 300 to 600 grams.

9. The cladded door apparatus of claim 1, wherein a 0.5 square inch of the one or more adhesive connectors have a static shear strength when tested at a temperature of 200 degrees F. that supports 150 to 350 grams.

10. The cladded door apparatus of claim 1, further comprising:
one or more cladding support members operatively coupled between the door and the one or more door cladding members.

11. The cladded door apparatus of claim 10, wherein the one or more cladding support members comprise a plurality of vertical and horizonal cladding support members that form a framework.

12. The cladded door apparatus of claim 10, wherein the one or more cladding support members comprise:
a plurality of brackets operatively coupled between the door and the one or more door cladding members.

13. The cladded door apparatus of claim 10, wherein the one or more cladding support members offset the one or more door cladding members a minimum of 0.25 inches from the door or a door frame.

14. The cladded door apparatus of claim 10, wherein the one or more cladding support members offset the one or more door cladding members a maximum of 1.75 inches from the door or a door frame.

15. The cladded door apparatus of claim 1, wherein the one or more door cladding members comprise non-combustible materials.

16. The cladded door apparatus of claim 1, wherein the one or more door cladding members comprise combustible materials.

17. A method of installing a cladded door apparatus, the method comprising:
assembling one or more adhesive connectors to a door and one or more door cladding members, wherein the one or more adhesive connectors are configured to disengage during a fire such that the one or more door cladding members uncouple from the door.

18. The method of claim 17, further comprising:
assembling one or more cladding support members to the door or the one or more door cladding members using the one or more adhesive connectors or other connectors.

19. The method of claim 18, wherein the one or more cladding support members offset the one or more door cladding members a minimum of 0.25 inches from the door or a door frame, and wherein the one or more cladding support members offset the one or more door cladding members a maximum of 1.75 inches from the door or the door frame.

20. The method of claim 17, wherein the cladded door apparatus is a fire rated door that meets a 90-minute rating and is in compliance with UL 10C, NFPA 252, or CAN/ULC S104; wherein a 0.5 square inch of the one or more adhesive connectors have a static shear strength when tested at a temperature of 72 degrees F. that supports 800 to 1200 grams; wherein a 0.5 square inch of the one or more adhesive connectors have a static shear strength when tested at a temperature of 150 degrees F. that supports 300 to 600 grams; and wherein a 0.5 square inch of the one or more adhesive connectors have a static shear strength when tested at a temperature of 200 degrees F. that supports 150 to 350 grams.
